(19) United States
(12) Patent Application Publication
(10) Pub. No.: US 2011/0183138 A1
(43) Pub. Date: Jul. 28, 2011

(54) METHOD FOR PRODUCING QUARTZ GLASS DOPED WITH NITROGEN AND QUARTZ GLASS GRAINS SUITABLE FOR CARRYING OUT THE METHOD

(75) Inventors: Martin Trommer, Bitterfeld-Wolfen (DE); Stefan Ochs, Camberg (DE); Juergen Weber, Kleinostheim (DE); Waltraud Werdecker, Hanau am Main (DE); Norbert Traeger, Maintal (DE); Helmut Leber, Hanau (DE)

(73) Assignee: Heraeus Quarzglas GmbH & Co. KG, Hanau (DE)

(21) Appl. No.: 12/737,468

(22) PCT Filed: Jul. 16, 2009
(86) PCT No.: PCT/EP2009/059141

§ 371 Date: Apr. 12, 2011

(30) Foreign Application Priority Data
Jul. 19, 2008 (DE) 102008033945.8

(51) Int. Cl. C03B 20/00; C03B 17/04; C03B 19/06; C03B 19/09

(52) U.S. Cl. 428/338; 65/30.1; 65/475; 65/60.5; 428/402

(57) ABSTRACT

In a known method for producing quartz glass that is doped with nitrogen, an SiO₂ base product is prepared in the form of SiO₂ grains or in the form of a porous semi-finished product produced from the SiO₂ grains and the SiO₂ base product is processed into the quartz glass with the nitrogen chemically bound therein in a hot process in an atmosphere containing a reaction gas containing nitrogen. From this starting point, a method is provided for achieving nitrogen doping in quartz glass with as high a fraction of chemically bound nitrogen as possible. This object is achieved according to the invention in that a nitrogen oxide is used as the nitrogen-containing reaction gas, and that a SiO₂ base product is used that in the hot process has a concentration of oxygen deficient defects of at least 2×10¹⁵ cm⁻³, wherein the SiO₂ base product comprises SiO2 particles having an average particle size in the range of 200 nm to 300 μm (D₅₀ value).

The present invention refers to a method for producing nitrogen-doped quartz glass in which a SiO₂ base product is provided in the form of SiO₂ grains or in the form of a porous semifinished product produced from the SiO₂ grains and the SiO₂ base product is processed into the quartz glass with the nitrogen chemically bound therein in a hot process in an atmosphere containing a reaction gas containing nitrogen.

Furthermore, the present invention refers to quartz glass grains suited for carrying out the method.

Components of quartz glass are often used for manufacturing processes which require high purity. The thermal stability of quartz glass is here a limiting factor. Temperature values of around 1150° C. are indicated in the literature as the lower softening point for quartz glass. However, it often happens that the necessary process temperatures are above said temperature, which may result in plastic deformations of the quartz glass components. Therefore, special emphasis has always been laid on the improvement of the thermal stability of quartz glass components, such as crucibles, tubes, holders, bell jars, or the like, and many measures have been suggested for this.

### PRIOR ART

As is generally known, a doping process with nitrogen increases the viscosity of quartz glass. Many methods are known to be used for nitrogen doping.

DE 10 2005 017 739 A1 describes a nitrogen-doped quartz glass for a wafer jig that is distinguished by high thermal stability and dry etching resistance. Nitrogen doping is effected by treatment of the quartz glass jig in an ammonia atmosphere at 1100° C. Since the in-diffusion of nitrogen into dense quartz glass is determined by diffusion, a near-surface nitrogen-loading of the quartz glass jig is achieved. To dope the whole volume, it is suggested that a still porous SiO₂ soot body should be sintered in an ammonia-containing atmosphere and subsequently vitrified at a temperature in the range of 1400° C.-2000° C. under overpressure in a non-oxidizing atmosphere. This procedure employed for doping a soot body with nitrogen is also known from DE 695 29 824 T2.

JP 54087534 A describes a method for producing quartz glass for optical applications according to the MCVD method. A substrate tube is here coated on the inside and doped with nitrogen for increasing the viscosity. The substrate tube is produced in that a porous start tube is provided that is doped with B₂O₃ in advance and the B₂O₃-doped phase is subsequently leached out. This porous tube is treated in an atmosphere containing ammonia and nitrogen monoxide (NO) at a treatment temperature below sintering temperature, resulting in nitrogen doping. Subsequently, the nitrogen-doped quartz glass tube is vitrified into the substrate tube.

GB 2129417 A describes outside and inside deposition methods for producing synthetic, nitrogen-doped quartz glass. Silicon-containing start substances are here formed in an atmosphere containing a nitrogen compound and an oxidizing compound. Ammonia is indicated as the nitrogen compound, and O₂, CO₂ or NO₂ as the oxidizing compound.

GB 1450123 A is concerned with the manufacture of optical fibers from quartz glass doped with nitrogen. The quartz glass is produced by way of a plasma deposition method. Ammonia is primarily recommended as the nitrogen-containing reaction partner, but other nitrogen compounds are also mentioned as oxidants, inter alia also nitrous oxide (N₂O).

EP 0 955 273 A1 describes an OVD method for producing an optical preform. A SiO₂ soot layer is deposited by using SiCl₄ on a substrate body rotating about its longitudinal axis, and said layer is subsequently sintered into a doped quartz glass. To reduce the reaction temperature during conversion of SiCl₄, nitrous oxide (N₂O) is used that simultaneously serves as an oxidant for SiCl₄ and thus as a reaction auxiliary for the conversion of SiCl₄.

JP 62176937 A describes a method for doping quartz glass with fluorine. To this end SiH₄ is oxidized in an oxygen-deficient atmosphere, whereby a porous soot body of substoichiometric SiO₂ (0<x<2) is formed. The porous soot body is then treated in a fluorine-containing atmosphere, wherein the silicon atom of the substoichiometric SiOₓ compound is meant to react with fluorine with formation of SiF₄.

U.S. Pat. No. 2,155,131 A discloses a crucible type drawing method for producing a quartz glass strand. A reducing atmosphere of nitrogen or of a mixture of nitrogen and hydrogen is produced in the drawing crucible.

DE 19541372 A describes a method for producing a quartz glass crucible, wherein a grain layer is applied to the inner wall of a crucible-like vacuum-type melt mold and vitrified by means of an electric arc. A gas stream of helium or nitrogen is here supplied to the interior of the melt mold and a vacuum that is operative through the wall is applied at the same time. This is to prevent the formation of gas-containing bubbles.

JP 4349191 A deals with a quartz glass crucible having an inner layer doped with nitrogen and carbon. Nitrogen doping is within the range of 100-4,000 ppm and set by heating the crucible by means of an electric arc in a nitrogen-containing atmosphere.

By comparison, the present invention refers to the nitrogen doping of quartz glass which is produced from granular SiO₂. A SiO₂ base product is here started from that is present either in the form of SiO₂ grains or as a porous semifinished product consisting of such grains. The grains are particulate SiO₂ with particle sizes in the μm-range, with the SiO₂ particles being produced synthetically or from naturally occurring raw material, such as crystalline quartz, or consisting of ground natural quartz glass, or of mixtures of said quartz glass qualities. The synthetic manufacturing methods for quartz-glass grains are generally known and comprise CVD methods or the so-called sol-gel method. Very finely divided SiO₂ powders are here often obtained that are further processed into granulates, which also represent SiO₂ grains within the meaning of this invention. Loose particles or mechanically or thermally pre-compacted porous moldings of SiO₂ grains or so-called “green compacts”, which are e.g. obtained in a slip casting method as porous intermediate product, constitute the semifinished product.

U.S. Pat. No. 6,381,986 B1 describes the doping of such base products with nitrogen for the purpose of improving the thermal stability and suggests a number of methods. For instance, a slip method is used for producing a nitrogen-doped quartz glass crucible. SiO₂ grains are received in a suspension and shaped into a porous green compact of the quartz-glass crucible. After drying of the green compact said compact is treated at a temperature in the range of 850° C. to 1200° C. in an ammonia-containing atmosphere and is then vitrified at high temperature. This yields a high concentration of nitrogen in the quartz glass network together with a high thermal resistance.

When ammonia is used for producing the nitrogen load of the quartz glass, hydrogen is simultaneously formed during decomposition of ammonia, the hydrogen leading to reducing melting conditions and to a distinct incorporation of hydroxyl groups into the quartz glass, which is accompanied by a decrease in the viscosity of the quartz glass.

The total nitrogen content of the quartz glass is composed of a fraction of physically dissolved nitrogen and a fraction of nitrogen which is firmly bound chemically in the network of the quartz glass. The nitrogen that is dissolved only physically is released upon heating of the doped quartz-glass crucible at relatively low temperatures and leads to the formation of bubbles and thus to an erosion of the crucible wall.

### OBJECT

It is therefore the object of the present invention to indicate a method by means of which nitrogen doping with as high a fraction of chemically bound nitrogen as possible can be achieved in quartz glass that is present as quartz glass grains.

It is the further object of the present invention to provide quartz glass grains particularly suited for carrying out said method.

As for the method, this object starting from the method of the aforementioned type is achieved according to the invention in that a nitrogen oxide is used as the nitrogen-containing reaction gas, and that a SiO₂ base product is used that in the hot process has a concentration of oxygen deficient defects of at least 2×10¹⁵ cm⁻³, wherein the SiO₂ base product comprises SiO₂ particles having a mean particle size in the range of 200 nm to 300 μm (D₅₀ value).

The SiO₂ base product in the form of grains or as a semifinished product formed from grains is subjected to a hot process at high temperature for the purpose of nitrogen doping. This hot process is either a melting or sintering process, in which a quartz glass component is produced from the grains or the semifinished product, wherein during the melting or sintering process the desired nitrogen loading of the quartz glass is produced (or a previously existing nitrogen loading is raised). Or this hot process is a doping step preceding the melting or sintering process, at the end of which nitrogen-loaded SiO₂ grains or a porous semifinished product loaded with nitrogen is obtained that is then further processed.

The nitrogen is introduced into the quartz glass of the SiO₂ base product via the gas phase, as is otherwise also known from the prior art. According to the invention a reaction gas is used that contains a nitrogen oxide or a plurality of nitrogen oxides. N₂O, NO, NO₂ and mixtures of said gases are e.g. suited as nitrogen oxide, and other gases, such as noble gases, oxygen, nitrogen or ammonia, may also be present.

During the thermal decomposition of nitrogen oxide, reactive nitrogen atoms evolve that may react already at low temperatures (<1,200° C.) with the quartz glass network with formation of Si—N, Si—ON, Si—NH bonds or other nitrogen bonds. These reactions lead to a firm chemical incorporation of the nitrogen into the quartz glass network.

Nitrogen loading of the quartz glass of the base product is carried out by way of a thermal-oxidative treatment of the base product over the gas phase. Due to the decomposition of the nitrogen oxide an atmosphere evolves that has an oxidizing effect and may also show an explosive reaction. Nitrogen loading therefore requires a technical environment (materials, atmosphere) that is resistant to oxidation or mainly insensitive. This may be a furnace and, as a preferred example, a rotary furnace should here be mentioned, a fluidized bed reactor, or a melting furnace or melting crucible. A partial pressure of the nitrogen oxide or of the nitrogen oxides of 1 atm is normally enough for an adequately high nitrogen loading. Upon loading under a higher partial pressure, higher nitrogen loadings can be achieved in the quartz glass, but foaming may easily occur under such loadings upon renewed heating up.

For instance, it has been found that the etching resistance can be increased by up to 80% in comparison with nitrogen-free quartz glass by way of doping with nitrogen according to the invention. On the other hand, in nitrogen-loaded quartz glass there is the risk that bubbles will form in subsequent hot processes. For instance, up to 300,000 wt. ppm nitrogen could be introduced into quartz glass in tests; this, however, results in a high bubble concentration and opacity. At a nitrogen content in the range of 2,000 to 3,000 wt. ppm, a transparent quartz glass can be produced with a bubble content that is low and acceptable for many applications. A quartz glass loaded with nitrogen at 2,000 wt. ppm still shows an improvement in the etching resistance of about 30% in comparison with nitrogen-free quartz glass.

It is essential in the method according to the invention that a SiO₂ base product should be used that in the hot process has a concentration of oxygen deficient defects of at least 2×10¹⁵ cm⁻³, preferably at least 1×10¹⁶ cm⁻³.

The network structure of quartz glass can show a multitude of defects. One group of such defects is formed by oxygen deficient defects in the case of which oxygen sites of the network are vacant or are occupied by other atoms. Known examples thereof are direct —Si—Si-bonds (163 nm and 243 nm′) and a silicon atom coordinated only twice (247 nm); the brackets are here indicating the absorption wavelength of the respective defect site. It has been found that reactive nitrogen atoms as are formed due to the decomposition of the nitrogen oxide can react particularly easily with existing vacancies in the quartz-glass network structure and especially with oxygen deficient defects. In the case of oxygen deficient defects the vacant oxygen sites are occupied by nitrogen, so that stable S—N-bonds are formed. This permits a particularly high loading of the quartz glass, namely with chemically bound nitrogen during conduction of the hot process (i.e. during doping, vitrifying (sintering) or melting of the base product). The concentration of oxygen deficient defects of at least 2×10¹⁵ cm⁻³ is set before or during the hot process.

The concentration of oxygen deficient defects in quartz glass is indirectly determined by the transmission loss. Transmission loss is here due to the separation of the oxygen vacancies under laser irradiation into two so-called E′ centers, which show a typical absorption at a wavelength of 210 nm.

In a SiO₂ base product of synthetic quartz glass the oxygen deficient defects can already be produced in the preparation of the SiO₂ particles. Alternatively, or as a supplement thereto, it has also turned out to be useful when the oxygen deficient defects are produced by a temperature treatment of the SiO₂ base product in an atmosphere showing a reducing action.

In this context it is also essential that the SiO₂ base product according to the invention consists of SiO₂ particles having a mean particle size in the range of 200 nm to 300 μm (D₅₀ value).

This regards finely divided grains with a large specific surface area that are advantageous both with respect to the later generation of defects and with respect to the loading of the SiO₂ particles with nitrogen, which loading is based on diffusion processes, because of the short diffusion paths. This means in particular that oxygen deficient defects arise in quartz glass more easily due to the atmosphere having a reducing action, due to high-energy radiation or due to high temperature, e.g. also still during the hot process for the purpose of vitrifying (sintering) or melting or nitrogen-loading the SiO₂ base product. It is here assumed that the nitrogen-loading mechanism is operative through the occupation of oxygen deficient defects only in near-surface regions of the base product.

Apart from the high etching resistance, the quartz glass obtained in this way is distinguished by a viscosity at a temperature of 1,200° C. of at least 10¹³ dPa's.

As for a high doping with nitrogen without the formation of bubbles, a SiO₂ base product is preferably used that in the hot process shows a concentration of oxygen deficient defects of at least 1×10¹⁶ cm⁻³.

A very high concentration of oxygen deficient defects (>2×10¹⁹ cm⁻³) can however contribute to an undesired high loading with nitrogen and to the foaming of the quartz glass during heating.

Furthermore, it has turned out to be advantageous when the SiO₂ base product consists of SiO₂ particles with a mean particle size in the range of 1 μm to 100 μm, particularly preferably with a mean particle size in the range of 2 μm to 60 μm (D₅₀ value each time).

This constitutes particularly finely divided grains with a large specific surface area and with the already above-explained effects with respect to the later generation of defects and the loading of the SiO₂ particles with nitrogen.

As for the production of a quartz glass having a very low bubble content and a low tendency to foaming at the same time, it has turned out to be advantageous when the nitrogen content of the quartz glass is set in the range between 1 wt. ppm and 150 wt. ppm.

Nitrogen contents of less than 1 wt. ppm have no major effect as regards etching resistance and thermal stability, and nitrogen contents of more than 150 wt. ppm already show a certain tendency to bubble formation; preferably, the nitrogen content is below 100 wt. ppm.

The nitrogen content is measured by means of a gas analysis method that is known as a “carrier hot-gas extraction”. An exactly weighed-in sample amount is heated in a graphite crucible to a very high temperature and the nitrogen gas released in this process is detected by way of the thermal conductivity of the measuring cells. For nitrogen the detection limit of this method is below 1 wt. ppm.

As a nitrogen-containing reaction gas, nitrous oxide has turned out to be particularly suited.

In small amounts, nitrous oxide (N₂O; laughing gas) is almost harmless to health. It decomposes at a temperature of about 650° C., thereby releasing reactive nitrogen that can react with the network structure of the quartz glass.

It has turned out to be advantageous when the nitrogen oxide content of the atmosphere during nitrogen loading is at least temporarily between 2 and 50 vol. %, preferably between 5 and 20 vol. %.

Nitrogen oxide contents below 2 vol. % result in insignificant nitrogen loading and in a small viscosity-enhancing effect, and nitrogen oxide contents above 50 vol. % can lead to an overloading with nitrogen and to bubble formation in subsequent high-temperature processes.

Preferably, the hot process comprises a treatment phase in which the SiO₂ base product is treated at a treatment temperature below 1,100° C., preferably in the temperature range between 650° C. and 1,000° C.

The temperature during the treatment phase for the purpose of nitriding the base product is chosen such that on the one hand the activation energy is available for the thermal decomposition of the nitrogen oxide and on the other hand an agglomeration of the SiO₂ particles or the formation of a dense-sintered layer inhibiting the further diffusion of the nitrogen oxide is avoided. It is thereby ensured that the gaseous treatment reagents can penetrate through the accumulation of SiO₂ particles or of the porous semifinished product and can uniformly react with the quartz glass network. This leads to a uniform distribution of the nitrogen oxide in a fill of SiO₂ particles or in a porous grain layer formed from the particles in the crucible production process, which contributes to a homogeneous nitrogen loading of the SiO₂ particles.

It has turned out to be particularly useful when the treatment phase includes a low-temperature treatment phase in which the treatment temperature is set to be lower than 500° C., preferably lower than 450° C.

During the low-temperature treatment phase the nitrogen oxide is distributed substantially uniformly within the permeable, porous SiO₂ base product, with a decomposition of the nitrogen oxide and the formation of Si—N bonds being suppressed in the quartz glass. The maximum temperature in this method step therefore depends on the nitrogen oxide used (the temperature values as are here indicated are optimal for N₂O). Because of the low temperatures the porous structure of the base product is maintained so that it is ensured that the gaseous treatment reagents penetrate through the porous and permeable base product and can uniformly disperse therein, and diffusion into near-surface regions of the SiO₂ particles can here also take place.

Furthermore, the treatment with nitrogen oxide includes a high-temperature treatment phase in which the treatment temperature is set to be higher than 500° C., preferably higher than 550° C., during the high-temperature treatment phase.

During the high-temperature treatment phase the nitrogen oxide is then thermally decomposed, so that the nitrogen oxide which has previously been uniformly disturbed in the base product and diffused thereinto now homogeneously reacts with the quartz glass and particularly with existing oxygen deficiency centers or other defects of the quartz glass structure. For the nitrogen oxide N₂O the preferred treatment temperature is in the range between 550° C. and 900° C. The high-temperature treatment phase is thus preferably preceded by a low-temperature treatment phase.

Furthermore, it has turned out to be useful when the SiO₂ base product is sintered or molten in a vitrification step into a transparent or opaque quartz glass, wherein the SiO₂ base product is subjected to the hot process for loading with nitrogen prior to the vitrification step.

A SiO₂ base product that has been loaded with nitrogen in advance is here used for the vitrification process. In the case of a base product of synthetically produced SiO₂, nitrogen loading is either carried out during particle preparation—a nitrogen loading during the sintering of SiO₂ granulate grains from agglomerates of SiO₂ nanoparticles is here particularly considered in an atmosphere containing the nitrogen oxide—or the nitrogen loading of the base product in the form of loose vitrified SiO₂ particles is carried out in an atmosphere containing the nitrogen oxide. An advantage of this procedure lies in the fact that a definite and verifiable nitrogen content can be set in the base product already before vitrification (sintering) or melting without the restrictive secondary conditions of the vitrifying or melting process. This improves the reproducibility of the method. Owing to additional nitriding during the vitrification step, possible losses of nitrogen can be compensated or avoided or the nitrogen concentration can be increased in the end product.

In a further preferred configuration of the method according to the invention it is intended that a mixture of synthetically produced SiO₂ particles and SiO₂ particles of naturally occurring raw material is used as the SiO₂ grains.

SiO₂ particles of synthetic material are normally very finely divided and are therefore not unrestrictedly usable for such melting methods or are only usable after processing, such as granulation. On the other hand, especially the synthetic SiO₂ particles can be provided relatively easily with defects of the network structure—also because of their small size. In the method variant according to the invention use is made of the naturally occurring SiO₂ particles that are also otherwise customary and are normally without oxygen defects or do not have very many, and these particles are mixed with synthetic SiO₂ particles that then permit a high loading of the quartz glass with chemically bound nitrogen because of their higher defect concentration. The synthetically produced SiO₂ particles can be loaded with nitrogen during vitrification or sintering, or they have already been loaded with nitrogen in advance.

It has turned out to be useful when no halogens are supplied to the atmosphere in the hot process.

The presence of halogens in the hot process leads to a loading of the quartz glass with halogens, partly in exchange for the desired nitrogen loading, and thus to a decrease in viscosity of the quartz glass.

As for the quartz glass grains, the aforementioned object is achieved according to the invention in that they contain synthetically produced SiO₂ particles with a mean particle size in the range of 200 nm to 300 μm that have a concentration of oxygen deficient defects of at least 2×10¹⁵ cm⁻³and are loaded with nitrogen in a mean concentration of not more than 3,000 wt. ppm and preferably in the range between 1 wt. ppm and 150 wt. ppm.

The grains according to the invention consist of SiO₂ soot dust, SiO₂ granulate, vitreous SiO₂ grains or of ground quartz glass powder. They are distinguished in that the synthetically produced SiO₂ particles have a mean particle size in the range of 200 nm to 300 μm and that they consist without exception or predominantly of quartz glass that contains a minimum content of oxygen deficient defects.

These finely divided grains provided with oxygen deficient defects are particularly well suited for a later loading with nitrogen under generation of nitrogen chemically bound in the quartz glass network. The relatively finely divided quartz glass grains (or granulate) are distinguished by a large specific surface area that is advantageous because of the short diffusion paths with respect to the loading of the SiO₂ particles with nitrogen, which loading is based on diffusion processes. Moreover, in the course of the further processing of the grains, additional oxygen deficient defects can arise more easily due to the atmosphere showing a reducing action or on account of high temperature, e.g. during vitrification (sintering) or melting. It is here assumed that the nitrogen loading mechanism is operative through the occupation of oxygen deficient defects only in near-surface regions of the grains.

The oxygen deficient defects in the quartz glass grains are e.g. produced in the preparation of the SiO₂ particles by setting an atmosphere with a reducing action, or alternatively or in addition by temperature treatment in an atmosphere with a reducing action at a temperature of at least 500° C.

The synthetically produced SiO₂ particles are first loaded with nitrogen in a mean concentration of not more than 3,000 wt. ppm and preferably in the range between 1 wt. ppm and 150 wt. ppm.

When quartz glass grains are used with a nitrogen content in the range of 2,000 to 3,000 wt. ppm, a quartz glass is producible with a bubble content that can be accepted for many applications, but that is improved with respect to etching resistance by about 30% in comparison with nitrogen-free quartz glass. For producing a quartz glass with a very low bubble content and with a low tendency to foaming at the same time, quartz glass grains are preferably used that have a nitrogen content of not more than 150 wt. ppm. Nitrogen contents below 1 wt. ppm show an insignificant effect with respect to etching resistance and thermal stability.

The quartz glass grains may be loaded with nitrogen by using nitrogen oxides, as has been explained further above, but also by using other nitrogen-containing compounds; nitrogen and ammonia should particularly be mentioned here.

It is important that in the doping process nitrogen should be available that can react with the defect centers of the glass network structure and can occupy the oxygen vacancies. A Si—N compound is here formed that leads to a chemical incorporation of the nitrogen into the quartz glass network.

When nitrogen compounds showing an oxidizing action (for example the above-mentioned nitrogen oxides) are used for nitrogen-loading, a further positive effect is achieved that is due to the fact that in addition to the atomic nitrogen also atomic oxygen is formed that at the same temperature is much more reactive than molecular oxygen and that reacts with oxidizable impurities, such as carbon-containing particles, hydrocarbons and organic impurities as may be contained due to the manufacturing process in SiO₂ powders, grains or granulates, whereby these are removed and can thus not result in drawbacks, e.g. inclusions or bubble formation, in subsequent hot working processes.

A further effect is achieved in the case of the nitrogen oxide treatment of quartz glass grains which have been purified in a hot chlorination process before and contain a residual content of chlorine. It has been found that the chlorine content can also be reduced by treatment in an atmosphere containing nitrogen oxide.

When ammonia is used for generating the nitrogen loading of the quartz glass, a distinct incorporation of hydroxyl groups into the quartz glass will be observed at temperatures above 1,250° C. due to the decomposition of the ammonia and the simultaneous presence of hydrogen, which may lead to a decrease in the viscosity of the quartz glass. As for the opposite effects, namely on the one hand decrease in viscosity due to incorporation of hydroxyl groups and on the other hand increase in viscosity due to incorporation of nitrogen, the use of ammonia will thus only be preferred if the nitriding temperature is below 1170° C. This drawback is not observed in nitrogen oxides that are free of hydrogen, so that these are preferably used for the nitrogen loading of the quartz glass grains according to the invention.

The higher the content of oxygen deficient defects is in the quartz glass grains, the easier will be the loading with nitrogen. Therefore, the synthetically produced SiO₂ particles in the quartz glass grains according to the invention have, preferably, a concentration of oxygen deficient defects of at least 1×10¹⁶ cm⁻³.

Furthermore, quartz glass grains have turned out to be particularly useful in the case of which the synthetically produced SiO₂ particles have a mean particle size in the range of 1 μm to 100 μm, particularly preferably a mean particle size in the range of 2 μm to 60 μm (D₅₀ value each time).

These are particularly finely divided quartz glass grains or granulates that very distinctly develop the already above-explained effects with respect to the loading with nitrogen and the formation of additional oxygen deficient defects.

In a particularly preferred configuration of the quartz glass grains according to the invention, these are present as a mixture of the synthetically produced SiO₂ particles and of particles of naturally occurring raw material.

SiO₂ particles of synthetic material are normally very finely divided and are difficult to handle for fusion processes, but can relatively easily be provided with defects of the network structure—also because of their small size. The naturally occurring SiO₂ particles are normally without oxygen defects or only have a few and are mixed with synthetic SiO₂ particles that then permit a high loading of the quartz glass with chemically bound nitrogen because of their higher defect concentration.

The quartz glass grains according to the invention are particularly suited for producing components which require a high thermal and chemical stability and particularly a high resistance to gases and liquids with an etching action. Such demands are e.g. often made on components in semiconductor production, in optics and in chemical process engineering.

In a first, particularly preferred intended use, the quartz glass grains according to the invention are used for producing a quartz glass strand from nitrogen-doped quartz glass by introducing the quartz glass grains into an interior space of a melting crucible and by melting them therein at a melting temperature of more than 2,000° C. in a nitrogen-containing atmosphere so as to obtain a softened quartz glass mass, and the softened quartz glass mass is drawn off as quartz glass strand from a drawing nozzle of the melting crucible.

This is a configuration of a crucible drawing method according to the invention by using quartz glass grains loaded with oxygen defect centers. It has been found that due to the high melting temperatures further numerous defect centers can be produced in the quartz glass, for instance —Si—Si—, —Si—H, —Si—OH, Si—O—O—Si—. In the traditional methods such defects of the network structure are saturated by randomly present molecules or atoms; these are often chlorine, OH groups or impurities existing in the interior of the melting crucible. The defect centers occupied in this way weaken the quartz glass network and in general deteriorate its properties, particularly temperature resistance and corrosion resistance, and they lead to a reduction of the viscosity and promote the tendency to devitrification. Moreover, there might occur an excessive bubble formation, for instance when the defects created are occupied by chlorine or other impurities, which may outgas in subsequent hot treatment steps.

The fusion grains, or a part thereof, can be loaded with nitrogen in advance. At any rate nitrogen is additionally offered in the interior of the melting crucible; due to the high temperatures of more than 2,000° C., the nitrogen can easily saturate the aforementioned and already existing defects additionally created in the fusion process, whereby firm Si—N bonds are created. This means that the nitrogen is firmly incorporated into the network of the quartz glass and will no longer gas out in later process steps.

It has turned out to be particularly advantageous when the atmosphere in the interior of the crucible contains hydrogen.

Apart from the nitrogen-containing reaction gas, the atmosphere contains hydrogen. The portion of hydrogen yields a reducing atmosphere that, also due to the high melting temperature, additionally contributes to the creation of oxygen deficiency sites in the network structure of the quartz glass grains that can be occupied subsequently or simultaneously by the offered nitrogen during the fusion process.

In this variant of the method, quartz glass grains are preferably used that consist of a mixture of the synthetically produced SiO₂ particles and of SiO₂ particles of naturally occurring raw material.

In an alternative, equally suited method variant, the quartz glass grains loaded with oxygen defect centers are used according to the invention for producing a quartz glass crucible from nitrogen-doped quartz glass in that a grain layer is formed from the quartz glass grains on an inner wall of a melting crucible and said layer is sintered in a nitrogen-containing atmosphere to obtain a quartz glass layer.

This method variant is concerned with a crucible melting process for producing a quartz glass crucible. Said crucible comprises a crucible wall which consists fully or in part of a nitrogen-doped quartz glass. The nitrogen-doped crucible wall or the nitrogen-doped part of the crucible wall, respectively, is formed from a grain layer in which the SiO₂ particles have been loaded with nitrogen in a separate doping process (as has been explained above) in advance, or in which the SiO₂ particles are loaded with nitrogen during the crucible melting process in that a reaction gas in the form of nitrogen, ammonia, nitrogen oxides or other gases containing nitrogen is supplied to the melting crucible atmosphere. The grains used in this case have oxygen defects, as has already been explained in detail further above.

### EMBODIMENT

The invention will now be described in detail with reference to an embodiment and a patent drawing. Shown is in detail in

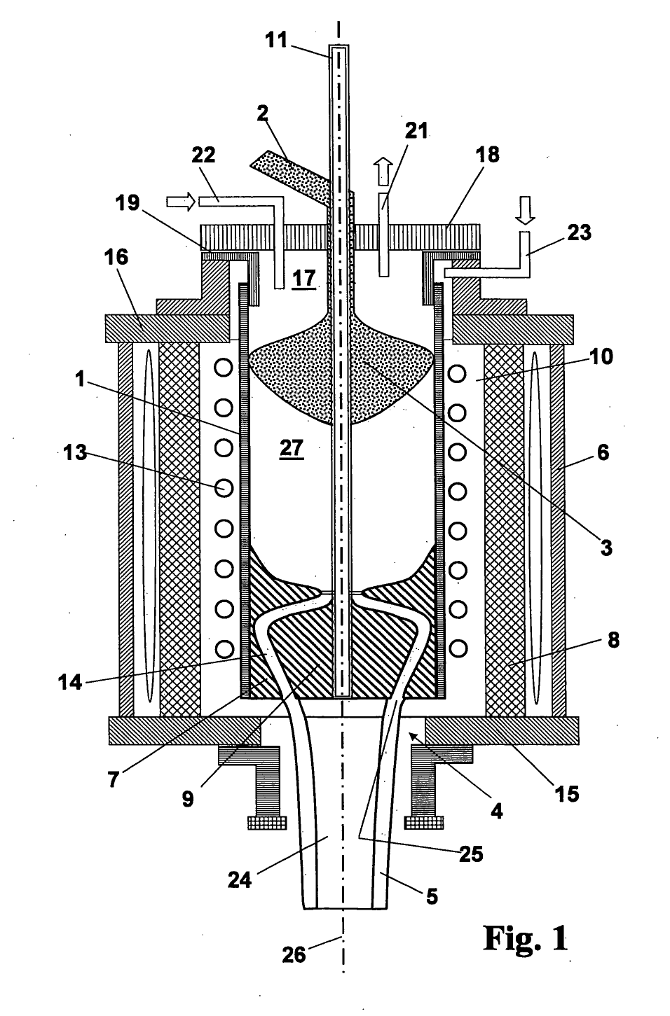

FIG. 1 a crucible melting device for drawing a strand of quartz glass according to the invention in a schematic illustration;

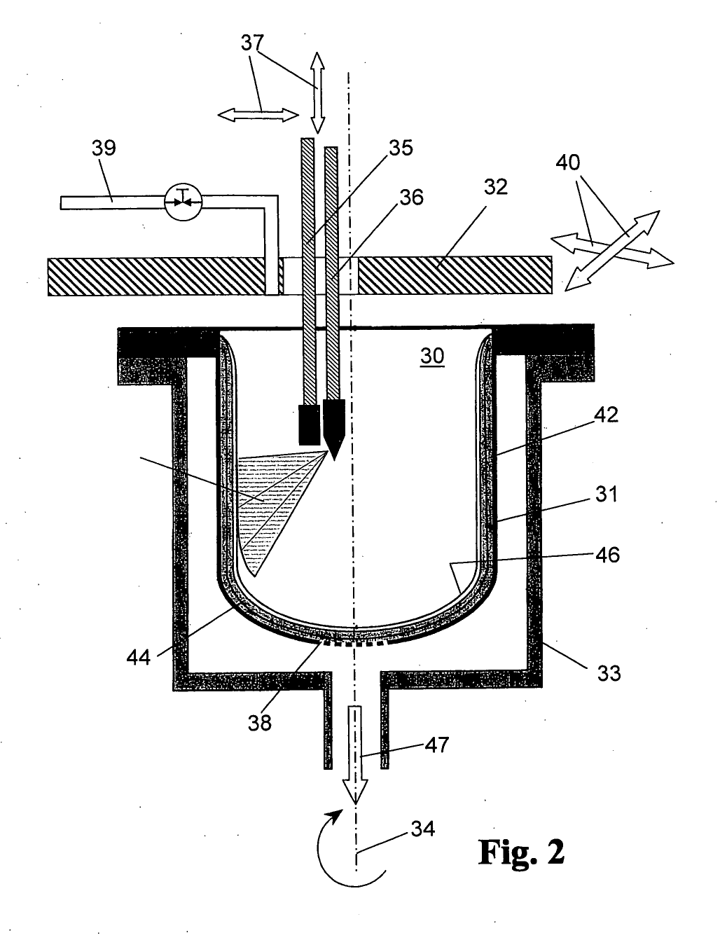

FIG. 2 a melting device for producing a crucible of quartz glass according to the invention in a schematic illustration;

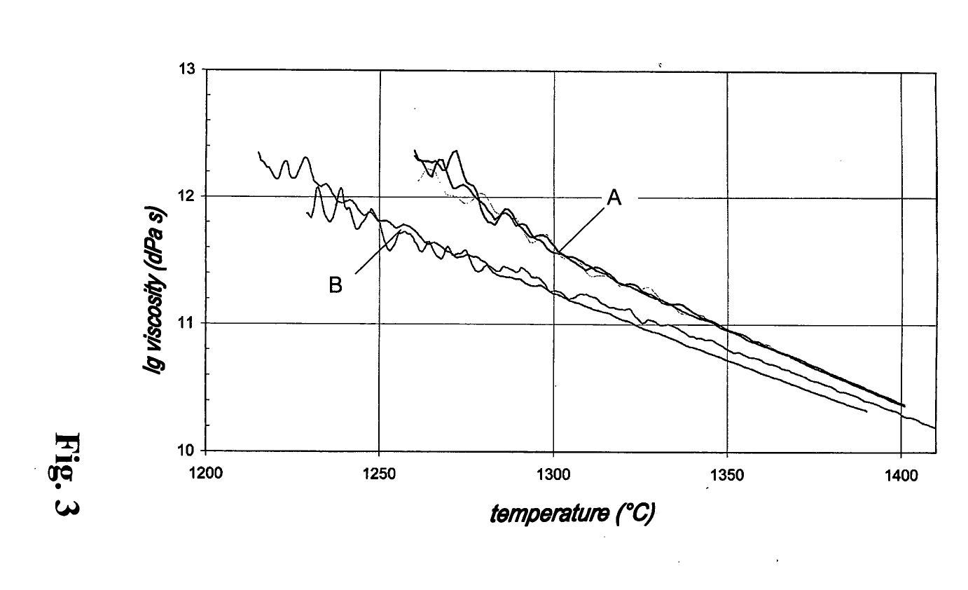

FIG. 3 a diagram with the viscosity progress over temperature in the case of a quartz glass according to the invention as compared with a quartz glass according to the prior art; and

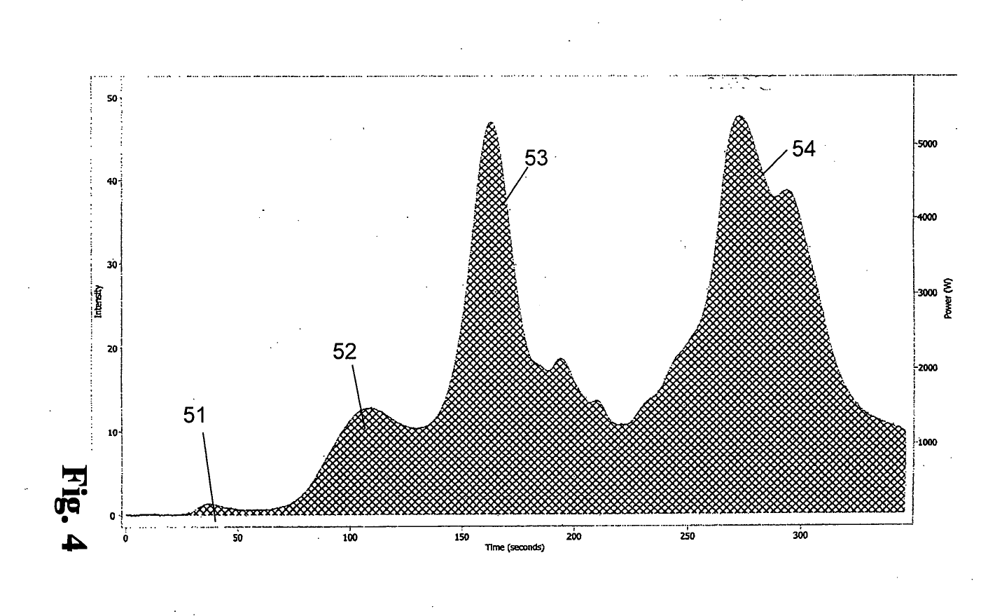

FIG. 4 the result of a hot gas extraction of a quartz glass according to the invention in the form of a diagram in which the outgassing volume is plotted versus the heating-up period (temperature).

### EXAMPLE 1

### Production of Quartz Glass with Oxygen Defects

SiO₂ soot bodies are produced by flame hydrolysis of SiCl₄ on the basis of the known OVD method. The nanoscale amorphous SiO₂ particles (soot dust) obtained thereby as filter dust are processed by means of a standard granulation method into a porous SiO₂ granulate. After the drying process the SiO₂ granulate is heated up in a heating furnace with a heating element of graphite to a temperature of about 850° C. and is pre-compacted. The graphite existing in the heating furnace causes the setting of reducing conditions. After a treatment duration of four hours a porous SiO₂ granulate is obtained.

The granulate is vitrified under vacuum at a temperature of about 1,300° C. This yields high-purity quartz glass grains of amorphous, spherical SiO₂ particles having a mean particle diameter of about 200 μm, which are distinguished by a hydroxyl group content of about 25 wt. ppm and a concentration of oxygen defect centers in the order of 1.7×10¹⁶ cm⁻³.

### EXAMPLE 2

### Loading the Porous SiO₂ Granulate with Nitrogen Prior to Vitrification

The oxygen defect-containing porous SiO₂ granulate produced in this way is subjected to an oxidative-thermal doping treatment and loaded with nitrogen. To this end a loose granulate is treated in a two-stage process first at a temperature of 450° C. for a period of 1 hour in a gas stream of N₂O (10 vol.-%), the balance being helium. This temperature is below the decomposition temperature of N₂O, which is evenly distributed in the loose granulate. In the second treatment phase the loose material is heated up to a temperature of 800° C. and the gas stream is replaced by a quiescent atmosphere of N₂O (10 vol. %), the balance being helium. The uniformly distributed N₂O decomposes with formation of atomic nitrogen and atomic oxygen. Some of the oxygen deficiency sites of the quartz glass are occupied by atomic nitrogen, which leads to the formation of Si—N bonds and thus to a chemical incorporation of nitrogen into the quartz glass network. Part of the atomic oxygen reacts with oxidizable impurities so that these can be discharged via the gas phase.

Depending on the duration of the second treatment phase and the N₂O content of the doping furnace, a nitrogen loading of the SiO₂ grains of 30 wt. ppm to 100 wt. ppm is thereby set. The porous granulate is subsequently vitrified into dense, nitrogen-doped quartz-glass grains, as described in Example 1.

### EXAMPLE 3

### Loading the Quartz Glass Grains After Vitrification with Nitrogen

The oxygen defect-containing, vitrified quartz glass grains according to Example 1 are subjected to an oxidative-thermal doping treatment and thereby loaded with nitrogen. To this end a particularly finely divided fraction of the grains with particles sizes of up to 100 μm is exposed in a two-stage process first at a temperature of 850° C. for a period of 1 hour to an atmosphere of NH₃ (20 vol. %), the balance being helium. This temperature is above the decomposition temperature of NH₃, which decomposes with formation of atomic nitrogen and reacts with the oxygen deficiency sites of the quartz glass while forming SiN—bonds. The furnace will subsequently be purged with He until the NH₃ is removed. The nitrogen-doped grains are then treated thermally in an atmosphere having an oxidizing action, which contains oxygen or a nitrogen oxide, at a temperature of 1,100° C. so as to eliminate oxidizable impurities and defects.

A nitrogen loading of the quartz glass grains of 10 wt. ppm to 50 wt. ppm is thereby set.

The oxygen defect-containing quartz glass grains obtained according to Example 1 and the oxygen defect-containing and nitrogen-doped quartz glass grains produced according to Examples 2 and 3 are used as raw material for producing nitrogen-doped quartz glass. This will be explained by way of example in more detail hereinafter with reference to the production of a nitrogen-doped quartz glass crucible in a crucible melt process and of a nitrogen-doped quartz glass tube in a crucible drawing method and with reference to FIGS. 1 and 2.

### EXAMPLE 4

### Drawing a Nitrogen-Doped Quartz Glass Tube from a Crucible

The drawing furnace according to FIG. 1 comprises a melting crucible 1 of tungsten into which SiO₂ grains 3 are continuously filled from above via a supply pipe 2. The SiO₂ grains 3 are a 50:50 mixture of the oxygen defect-containing quartz glass grains explained above with reference to Example 1 (without nitrogen doping) and of grains of naturally occurring raw material of quartz.

The melting crucible 1 is surrounded by a water-cooled furnace jacket 6 with formation of a protective gas chamber 10 purged with protective gas, which accommodates a porous insulation layer 8 of oxidic insulation material and a resistance heater 13 for heating the SiO₂ grains 3. The protective gas chamber 10 is open downwards and otherwise sealed with a bottom plate 15 and a cover plate 16 to the outside. The melting crucible 1 encloses a crucible interior 17 which is also sealed to the environment by means of a cover 18 and a sealing element 19.

An inlet 22 and an outlet 21 for a crucible interior gas project through the cover 18. This gas is a mixture of 90 vol. % hydrogen and 10 vol. % N₂. The protective gas chamber 10 is provided in the upper portion with a gas inlet 23 for pure hydrogen.

A drawing nozzle 4 of tungsten is positioned in the bottom portion of the melting crucible. This nozzle is composed of a drawing-nozzle exterior part 7 and a mandrel 9.

Very high temperatures of around 2100° C. prevail in the interior of the melting crucible. Apart from the already existing defects, these temperatures additionally form defects in the quartz glass network of the grains. The nitrogen existing in the interior 17 of the crucible reacts with the existing oxygen deficiency sites of the quartz glass grains. A certain moderate amount of nitrogen is thereby chemically bound in the quartz glass network.

The soft quartz glass mass 27 passes via a flow channel 14 to the nozzle outlet 25 and is vertically drawn off downwards in the direction of the drawing axis 26 as a tubular strand 5 with an inner diameter of 190 mm and an outer diameter of 210 mm.

The mandrel 9 of the drawing nozzle 4 is connected to a holding tube 11 of tungsten that extends through the interior 17 of the crucible and is guided through the upper cover 19 out of said interior. Apart from holding the mandrel 9, the holding tube 11 also serves to supply a process gas for setting a predetermined blow pressure in the inner bore 24 of the tubular strand 5.

The quartz glass of the tubular strand contains a concentration of chemically bound nitrogen of about 100 wt. ppm, a concentration of hydroxyl groups of less than 1 wt. ppm, and it is distinguished by high viscosity and etching resistance.

### EXAMPLE 5

### Producing a Nitrogen-Doped Quartz Glass Crucible

The melting device according to FIG. 2 comprises a melting mold 31 of metal having an inner diameter of 75 cm, which rests with an outer flange on a carrier 33. The carrier 33 is rotatable about the central axis 34. A cathode 35 and an anode 36 (electrodes 35; 36) of graphite project into the interior 30 of the melting mold 31; as outlined with the directional arrows 37, these are movable within the melting mold 31 in all spatial directions.

The open upper side of the melting mold 31 is covered by a heat shield 32 in the form of a water-cooled metal plate that has a central through-hole through which the electrodes 35, 36 project into the melting mold 31. The heat shield 32 is provided with a gas inlet 39 for a process gas. The process gas is either a gas mixture of 80 vol.-% He/20 vol.-% O₂ or a gas mixture of 60 vol.-% He/40 vol.-% N₂O.

A venting gap with a width of 50 mm is provided between the melting mold 31 and the heat shield 32 (FIG. 1 show this dimension and all of the other dimensions of the device only schematically, not true to scale). The heat shield 32 is horizontally movable (in x- and y-direction) in the plane above the melting mold 31, as is outlined by the directional arrows 40.

The space between the carrier 33 and the melting mold 31 is evacuable by means of a vacuum device, which is represented by the directional arrow 47. The melting mold 31 comprises a plurality of passages 38 (these are outlined only symbolically in the bottom area in FIG. 2), through which the vacuum 47 applied to the outside of the mold 31 can act inwards.

In a first method step, crystalline grains of natural quartz sand, cleaned by hot chlorination, with a grain size ranging from 90 μm to 315 μm, is filled into the melting mold 31 rotating about its longitudinal axis 34. Under the action of the centrifugal force and by means of a shape template a rotation-symmetrical crucible-like grain layer 42 of mechanically compacted quartz sand is formed on the inner wall of the melting mold 31. The mean layer thickness of the grain layer 42 is about 12 mm.

In a second method step, the inner wall of the quartz sand layer 42 has formed thereon an intermediate grain layer 44 of quartz glass grains doped according to the above Example 2 in advance with nitrogen in an amount of 80 wt. ppm and consisting of synthetically produced SiO₂, also by using a shape template and under continued rotation of the melting mold 31. The mean layer thickness of the intermediate grain layer 44 is also about 12 mm.

In a third method step, a further SiO₂ grain layer (46) with a mean thickness of about 3 mm is formed on the intermediate grain layer 44, also by using a shape template and under continued rotation of the melting mold 31; said further SiO₂ grain layer is formed from “inner layer grains” that are neither nitrogen-loaded nor have oxygen deficiency sites (below the detection limit) and otherwise correspond to the quartz glass grains used for forming the intermediate layer.

In a further method step the grain layers 42, 44 and 46 are vitrified. A constant and controlled process gas stream of the helium/oxygen mixture (80 He/20 O₂) is supplied at 300 l/min to the interior 30 via the gas inlet 39. The melting process is completed before the melt front reaches the inner wall of the melting mold 31.

The inner surface of the quartz glass crucible produced in this way is formed by a smooth, vitreous and low-bubble inner layer of synthetic SiO₂ which is firmly connected to an outer layer of opaque quartz glass. About half the thickness of the outer layer is formed by the quartz glass doped with nitrogen in an amount of about 80 wt. ppm, whereas the inner layer is free of nitrogen. The quartz glass crucible is distinguished by a high thermal stability and a long service life.

The quartz glass produced with the help of the method according to the invention and by using the quartz glass grains according to the invention was tested with respect to its viscosity and its foaming behavior.

The diagram of FIG. 3 shows viscosity profiles over the temperature range of 1,200° C. to 1,400° C. of standard quartz glasses “B” without nitrogen doping as compared with a plurality of quartz glass qualities “A” according to the invention with nitrogen dopings in the range of 50 wt. ppm to 100 wt. ppm. As can be seen, the viscosity of the quartz glasses “A” doped with nitrogen and produced according to the invention is much higher under otherwise identical characteristics (hydroxyl group content, chlorine content) than the viscosity of standard quartz glass “B”.

The diagram of FIG. 4 shows the result of a hot gas extraction of a quartz glass according to the invention with a mean nitrogen content of about 150 wt. ppm. The intensity signal of the measuring cell which is proportional to the nitrogen volume gassing out of the quartz glass is plotted on the y-axis, and the measurement period in seconds on the x-axis, wherein for the duration of the measurement a temperature ramp between 1,000° C. and 2,200° C. is traced at a ramp speed of 20 watt/s.

Maxima of the nitrogen outgassing process can be observed at temperatures of about 1,020° C. (51), 1,500° C. (52), 1,800° C. (53) and 2,200° C. (54), with the two first maxima being negligible. The first significant maximum 53 of the nitrogen outgassing process is thus observed at a temperature of 1,800° C. This temperature is higher than standard sintering temperatures of quartz glass grains, so that the nitrogen amount outgassing at the temperature of around 1,800° C. remains normally in the quartz glass in sintering processes and does not lead to the formation of bubbles.

The maximum outgassing volume 54 occurs only at a temperature of about 2,200° C. This, however, is a temperature that is so high that it is not even reached in standard forming processes of quartz glass. Therefore, the quartz glass of the invention does in fact not exhibit any significant foaming during the forming process, as e.g. in a homogenizing process by twisting or the like.

1. A method for producing nitrogen-doped quartz glass, said method comprising:
providing a SiO₂ base product in the form of SiO₂ grains or in the form of a porous semifinished product produced from the SiO₂ grains; and
processing the SiO₂ base product into the quartz glass with nitrogen chemically bound therein in a hot process in an atmosphere containing a reaction gas containing nitrogen,
wherein the nitrogen-containing reaction gas is nitrogen oxide; and the SiO₂ base product that is used in the hot process has a concentration of oxygen deficient defects of at least 2×10¹⁵ cm⁻³, wherein the SiO₂ base product comprises SiO₂ particles having a mean particle size in the range of 200 nm to 300 μm (D₅₀ value).

2. The method according to claim 1, wherein said base product that is used in the hot process has a concentration of oxygen deficient defects of at least 1×10¹⁶ cm⁻³.

3. The method according to claim 2, wherein the oxygen deficient defects are produced by a temperature treatment of the SiO₂ base product in an atmosphere showing a reducing action.

4. The method according to claim 1, wherein the SiO₂ base product is formed of SiO₂ particles having a mean particle size in the range of 1 μm to 200 μm (D₅₀ value each time).

5. The method according to claim 1, wherein nitrous oxide is used as the nitrogen-containing reaction gas.

6. The method according to claim 1, wherein the quartz glass has a nitrogen content with a mean value in the range between 1 wt. ppm and 150 wt. ppm.

7. The method according to claim 1, wherein the atmosphere during the hot process has a nitrogen content that is at least temporarily between 2 and 50 vol. %.

8. The method according to claim 1, wherein the hot process comprises a treatment phase in which the SiO₂ base product is treated at a treatment temperature below 1,100° C.

9. The method according to claim 8, wherein the treatment phase includes a low-temperature treatment phase in which the treatment temperature is lower than 500° C.

10. The method according to claim 8, wherein the treatment phase includes a high-temperature treatment phase in which the treatment temperature is higher than 500° C.

11. The method according to claim 10, wherein the treatment temperature is in a range between 550° C. and 750° C. during the high-temperature treatment phase.

12. The method according to claim 1, wherein the SiO₂ base product is sintered or molten in a vitrification step so as to obtain a transparent or opaque quartz glass, and the SiO₂ base product is subjected to the hot process and loading with nitrogen prior to the vitrification step.

13. The method according to claim 1, wherein said SiO₂ grains of the SiO₂ base product comprise a mixture of synthetically produced SiO₂ particles and particles of naturally occurring raw material.

14. The method according to claim 1, wherein no halogens are supplied to the atmosphere in the hot process.

15. Quartz glass material comprising: quartz glass grains that contain synthetically produced SiO₂ particles with a mean particle size in the range of 200 nm to 300 μm said SiO₂ particles having a concentration of oxygen deficient defects of at least 2×10¹⁵ cm⁻³; and
being loaded with nitrogen in a mean concentration of not more than 3,000 wt. ppm.

16. The quartz glass material according to claim 15, wherein said synthetically produced SiO₂ particles have a concentration of oxygen deficient defects of at least 1×10¹⁶ cm⁻³.

17. The quartz glass material according to claim 15, wherein the synthetically produced SiO₂ particles have a mean particle size in a range of 1 μm to 100 μm (D₅₀ value each time).

18. The quartz glass material according to claim 15, wherein said Quartz glass grains are present as a mixture of the synthetically produced SiO₂ particles and of particles of naturally occurring raw material.

19. A method for producing a quartz glass strand, said method comprising:
providing nitrogen-doped quartz glass material according to claim 15, wherein the quartz glass grains are introduced into an interior space of a melting crucible and are molten therein at a melting temperature of more than 2,000° C. in a nitrogen-containing atmosphere so as to obtain a softened quartz glass mass, and the softened quartz glass mass is drawn off as the quartz glass strand from a drawing nozzle of the melting crucible.

20. The method according to claim 19, wherein the atmosphere in the interior of the crucible contains hydrogen.

21. A method for producing a quartz glass crucible, said method comprising:
providing nitrogen-doped quartz glass material according to claim 15 and;
forming a grain layer from the quartz glass grains on an inner wall of a melting crucible, and said grain layer is sintered in a nitrogen-containing atmosphere so as to form a quartz glass layer.

22. The method according to claim 1, wherein the SiO₂ base product is formed of SiO₂ particles having a mean particle size in the range of 2 μm to 60 μm (D₅₀ value each time).

23. The method according to claim 1, wherein the atmosphere during the hot process has a nitrogen content that is at least temporarily between 5 and 20 vol. %

24. The method according to claim 1, wherein the hot process comprises a treatment phase in which the SiO₂ base product is treated in a treatment temperature range between 650° C. and 1,000° C.

25. The method according to claim 8, wherein the treatment phase includes a low-temperature treatment phase in which the treatment temperature is lower than 450° C.

26. The method according to claim 8, wherein the treatment phase includes a high-temperature treatment phase in which the treatment temperature is higher than 550° C.

27. Quartz glass material grains comprising: quartz glass grains that contain synthetically produced SiO₂ particles with a mean particle size in the range of 200 nm to 300 μm said SiO₂ particles having a concentration of oxygen deficient defects of at least 2×10¹⁵ cm⁻³; and being loaded with nitrogen in a range between 1 wt. ppm and 150 wt. ppm.

28. The quartz glass material according to claim 15, wherein the synthetically produced SiO₂ particles have a mean particle size in a range of 2 μm to 60 μm (D₅₀ value each time).
